(19) United States
(12) Patent Application Publication
(10) Pub. No.: US 2015/0371245 A1
(43) Pub. Date: Dec. 24, 2015

(54) Airline Sales Forecasting and Budgeting Tool

(71) Applicant: Diio, LLC, Reston, VA (US)

(72) Inventors: David BENTAL, Encino, CA (US); Matthew SCHNITZ, Pasadena, CA (US)

(21) Appl. No.: 14/745,078

(22) Filed: Jun. 19, 2015

Related U.S. Application Data
(60) Provisional application No. 62/014,743, filed on Jun. 20, 2014.

(51) Int. Cl. G06Q 30/02; G06Q 50/30; G06Q 10/02

(52) U.S. Cl. CPC G06Q 30/0202; G06Q 10/025; G06Q 50/30

(57) ABSTRACT

A computer-implemented method is provided for forecasting passengers for a given carrier in a given market. The method includes: receiving an expected percentage change in market share for a given itinerary of the carrier during a future time period; receiving a quantity of passengers transported by the carrier via the given itinerary during a preceding time period; determining a percentage change in quantity of passengers in the given market during the future time period; and determining a forecasted quantity of passengers transported by the carrier during the future time period as a function of the quantity of passengers transported by the carrier via the given itinerary during a preceding time period, the expected percentage change in market share for the given itinerary during a future time period and the percentage change in quantity of passengers in the given market during the future time period.

### CROSS-REFERENCE TO RELATED APPLICATIONS

This application claims the benefit and priority of U.S. Provisional Patent Application No. 62/014,743 filed Jun. 20, 2014. The entire disclosure of the above application is incorporated herein by reference.

### FIELD

The present disclosure relates to techniques for forecasting passengers for a carrier, such as an airline.

### BACKGROUND

Airlines are continuing to look for new ways to increase revenue and maximize profits. Forecasting and budgeting tools are typically used to predict the expected demand in a given market, i.e., the number of passengers expected to be transported by the airline in the given market and in turn the performance of the network. The output of the forecast can then be used by an airline to adjust the schedule to meet the expected demand, provide revenue and operational budgets, and help in managing the performance of the airline. Conventional techniques for predicting the market demand during a future time period are fraught with inaccuracies, thereby leading to unreliable results. Therefore, there is a need to develop improved techniques for forecasting market demand for airlines or other carriers in a more reliable manner to drive better budgeting decisions.

This section provides background information related to the present disclosure which is not necessarily prior art.

### SUMMARY

This section provides a general summary of the disclosure, and is not a comprehensive disclosure of its full scope or all of its features.

A computer-implemented method is provided for forecasting passengers for a given carrier in a given market. The method includes: receiving an expected percentage change in market share for a given itinerary of the carrier during a future time period; receiving a quantity of passengers transported by the carrier via the given itinerary during a preceding time period; determining a percentage change in quantity of passengers in the given market during the future time period; and determining a forecasted quantity of passengers transported by the carrier during the future time period as a function of the quantity of passengers transported by the carrier via the given itinerary during a preceding time period, the expected percentage change in market share for the given itinerary during a future time period and the percentage change in quantity of passengers in the given market during the future time period. More specifically, the forecasted quantity of passengers can be computed by multiplying the quantity of passengers transported by the carrier via the given itinerary during a preceding time period by a carrier forecast ratio indicative of the expected percentage change in market share for the given itinerary of the carrier during a future time period and by a market forecast ratio indicative of the percentage change in quantity of passengers in the given market during the future time period.

In one aspect of this disclosure, itineraries of the carrier during the future time period are adjusted based on the forecasted quantity of passengers.

In another aspect of this disclosure, an expected percentage change in a carrier's given itinerary is estimated by determining a forecasted quality of service index (QSI) share for the given itinerary of the carrier in the future time period; determining a historic QSI share for the given itinerary of the carrier in the preceding time period; and determining the expected percentage change in the carrier's future market share based on the forecasted QSI share by the historic QSI share.

In yet another aspect of this disclosure, a percentage change is the overall market size is estimated by determining a forecasted quality of service index (QSI) score for a select group of carriers servicing the given market in the future time period; determining a historic QSI score for the select group of carriers in the given market in the preceding time period; and determining a forecasted percentage change in the overall market based on the forecasted QSI score and the historic QSI score.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a diagram depicting a system for forecasting passengers for a carrier in a given market;

FIG. 2 is a flowchart depicting an example technique for forecasting passengers in accordance with this disclosure;

FIG. 3 is a process flow diagram depicting an example embodiment for forecasting passengers;

FIG. 4 is a diagram illustrating a method for estimating unconstrained demand;

FIG. 5 is a depiction of an example user interface used to create a new forecast;

FIGS. 6A-6C are depictions of example reports generated by the forecasting tool; and

FIG. 7 is a flowchart depicting an example technique for forecasting cargo capacity in accordance with this disclosure;

Corresponding reference numerals indicate corresponding parts throughout the several views of the drawings.

### DETAILED DESCRIPTION

Example embodiments will now be described more fully with reference to the accompanying drawings.

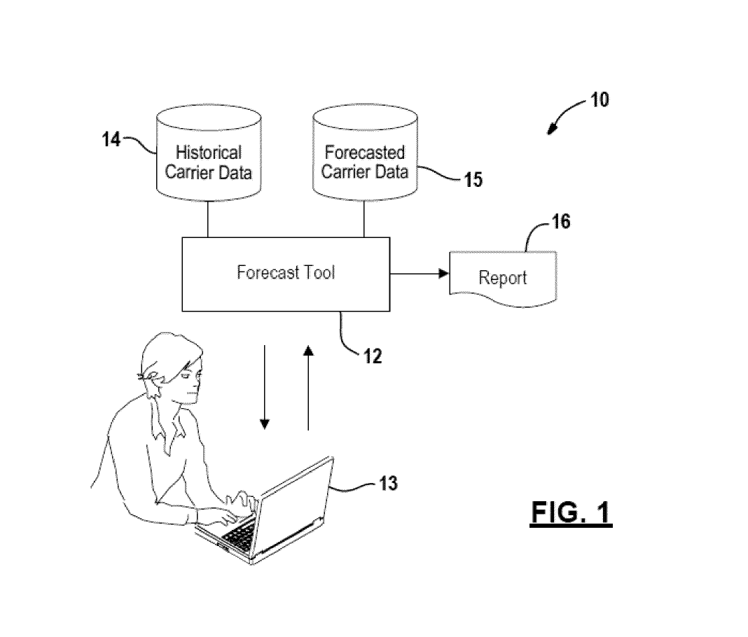

FIG. 1 illustrates a system 10 for forecasting passengers for a carrier, such as an airline. The system is comprised generally of a software-implemented forecasting tool 12 residing on a computing device 13. The forecasting tool 12 may have access to one or more data sources associated with the carrier. For example, the forecasting tool 12 may access a source of historical data 14 for the carrier and/or the industry as well as a source of projected data 15 for the carrier and/or the industry. The forecasting tool 12 may operate to generate various types of reports as will be further described below. In some embodiments, forecasted quantities of passengers for a given itinerary are feed into a scheduling system (not shown) such that future itineraries are adjusted by the scheduling system based in the forecasted quantities of passengers. In other embodiments, forecasted quantities are used to set operational budgets. While the computing device 13 is shown as a laptop computer, it is readily understood that the forecasting tool 12 may reside on or be accessed from other types of computing devices, such as desktops, tablets, mobile phones, etc.

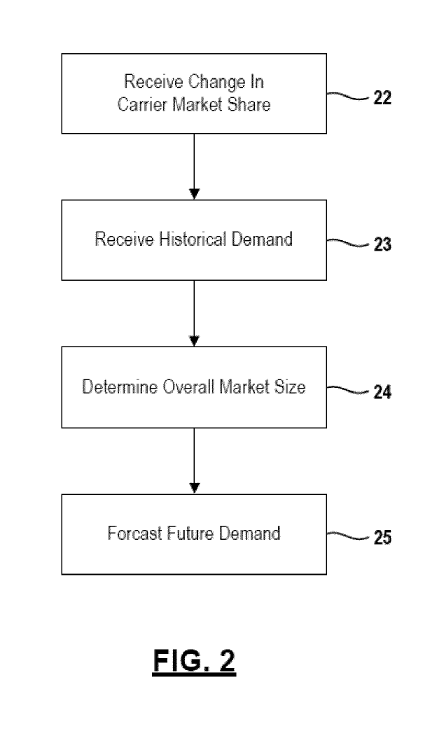

FIG. 2 depicts an example method 20 for forecasting passengers which may be implemented by the forecasting tool 12. In the example method, a market is defined by an origin and a destination. One or more itineraries are provided by a given carrier for transporting passengers in the market, i.e., between the origin to the destination. For illustration purposes, the carrier is further defined as an airline. It is readily understood that the concepts described here are extendable to other types of carriers, such as buses, trains, etc.

One input to the method is the expected change in market share for the given carrier in the market being analyzed. More specifically, the expected change in the carrier's market share for a given itinerary in a future time period (i.e., forecast period) is received at 22 by the tool. The forecast period is typically a user defined parameter having a value of one month although other values are contemplated as well. In one embodiment, the expected change in market share for the itinerary is signified as a carrier forecast ratio, where the carrier forecast ratio is set to one plus a percentage value input into the forecasting tool 12 by the tool user. In this case, the change in market share may have been computed by the tool user in a variety of ways. In another embodiment, the expected change in market share may be estimated by the tool using a quality of service index (QSI) for the given carrier as will be further described below.

QSI is a metric that quantifies the value of travel itineraries to passengers for a given carrier in a given market and is readily known in the airline industry. QSI may be derived from various factors including but not limited to number of stops by the carrier between an origin and a destination, the type of aircraft (e.g., widebody jet, narrowbody jet, turboprop, etc.), flight frequency (how many different flights in a day), travel time, and time-of-day (during business hours v. outside of business hours). It is understood that different techniques for computing QSI are employed by different airlines but such variations fall within the broader aspects of this disclosure.

Another input to the method is the historical demand for the carrier's given itinerary as indicate at 23. The historical demand for the carrier's itinerary is defined as the quantity of passengers transported by the given carrier via the given itinerary during a preceding time period, where the preceding time period is substantially equal to the future time period. In one embodiment, the historical demand is a count of passengers actually transported by the given carrier via the given itinerary which is retrieved directly from a data source, such as data store 14. It is appreciated that the count is constrained by the number of seats available on the carrier's flights servicing the given market. In another embodiment, the historical demand may correspond to an estimate of passengers who would have flown via the given itinerary with the given carrier assuming unconstrained seat capacity. This example metric will be further described below.

An expected change in the overall size of the given market also serves as an input to the example method as indicated at 24. Different techniques may be employed to determine an expected change in the overall market size during the forecast period. Rather than trying to quantify the market size in terms of the number of passengers expected to travel, the example method relies upon a percentage change in the market size. In one embodiment, the expected change in the overall market size is signified a market forecast ratio, where the market forecast ratio is set to one plus a percentage value input by the tool user into the forecasting tool 12. In another embodiment, the expected change in the market size may be estimated using the QSI score for a select group of carriers servicing the market (e.g., all of the airlines servicing the market or a subset thereof) as will be further described below. Other techniques for obtaining the expected change in overall market size are contemplated by this disclosure.

A quantity of passengers expected to be transported by the given airline during the forecast period can then be determined at 25 as a function of the quantity of passengers transported by the carrier via the given itinerary during a preceding time period, the expected percentage change in market share for the given itinerary during a future time period and the percentage change in quantity of passengers in the given market during the future time period. More specifically, the forecasted quantity of passengers is computed by multiplying the quantity of passengers transported by the carrier via the given itinerary during a preceding time period by the carrier forecast ratio (i.e., one plus the expected percentage change in market share for the given itinerary of the carrier during a future time period) and by the market forecast ratio (i.e., one plus the percentage change in quantity of passengers in the given market during the future time period). For illustration purposes, assume the quantity of passengers transported by the carrier via the given itinerary during a preceding time period is 200, the expected percentage change in market share for the given itinerary of the carrier during a future time period is 10% (such that carrier forecast ratio is 1.1), and the percentage change in quantity of passengers in the given market during the future time period is −4% (such that market forecast ratio is 0.96). In this example, the forecasted quantity of passengers is computed as follows:

forecasted passengers=200*1.1*0.96=211.2

Other functions for estimating the quantity of passengers expected to be transported by the given airline during the forecast period are also contemplated by this disclosure.

In some embodiments, the expected percentage change is estimated using a ratio of the airline's QSI share for the given itinerary during the future period (i.e., forecast QSI share) in relation to the airline's QSI share for the given itinerary during a historical period (i.e., historical QSI share). QSI share in future periods can be computed using an airline's future schedule data. Raw QSI scores can be inaccurate; the various weighting factors which go into calculating a QSI score can work against each other, such that tuning the score to a particular market causes the score in other markets to be incorrect. However, QSI scores are inaccurate in a manner that is generally consistent across time, and therefore a ratio of QSI shares will tend to cancel out any error and thereby improves the overall accuracy of the method. By way of example, an airline's forecast QSI share is computed by dividing the QSI points for the itinerary offered by the airline in the given market during the forecast period by the sum of QSI points for all itineraries offered by all airlines (including the airline of interest) in the given market during the forecast period. Likewise, an airline's historical QSI share is computed by dividing the QSI points for the itinerary offered by the airline in the given market during the historical period by the sum of QSI points for all itineraries offered by all airlines (including the airline of interest) in the given market during the historical period. In the event an airline's flight schedules for the forecast period are unavailable, the forecast tool 12 enables a user to select a representative historical schedule for the market and compute the airline's forecast QSI share using the selected schedule. It follows that to compute the forecast demand, the expected percentage change in market share for the given itinerary of the carrier can be set to forecast QSI share divided by historical QSI share minus one.

Likewise, the percentage change in quantity of passengers in the given market during the future time period can be derived from QSI scores. For example, the percent change in market size can be estimated by dividing the forecast QSI scores for all itineraries serving a given market by historical QSI scores for all itineraries serving a given market. It then follows that to computer forecast demand, the value of market forecast ratio can be set to this quotient minus one. Other ways of estimating the expected change in market share are contemplated by this disclosure as noted above.

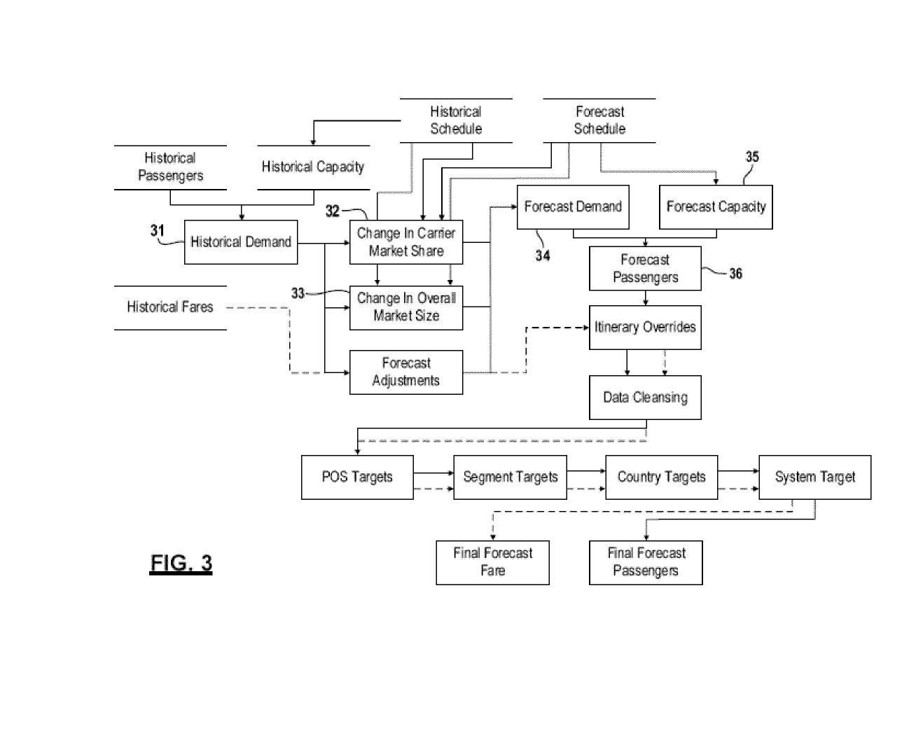

FIG. 3 further describes an example implementation of the method set forth above. In this example embodiment, historical demand for a given carrier is first estimated at 31 assuming unconstrained seat capacity. Unconstrained demand represents the number of passengers who would have selected a particular flight or route if an unlimited number of seats were available. In reality, passenger demand varies widely from day to day while seat capacity is fixed, so a nonstop route that recorded 70 percent of its seats occupied (load factor) during a particular month likely had some days during which the flights were completely full, and so some potential passengers who wanted to travel on those flights but could not be accommodated were “spilled” (i.e., did not fly with the carrier). Generally, as load factors rise (i.e., flights become fuller), more and more passengers are “spilled” during peak days.

In this example embodiment, historical demand may be estimated with an iterative process applied to each segment of an itinerary as further described below. For example, a first demand estimate is set to the greater of a base historical demand estimate or a historical number of passengers. In this example, the base historical demand estimate can be computed as the number of historical passengers+(two*the capped seed estimate), where the number of historical passengers is the sum of all passengers from all itineraries in a particular flight segment. When the base seed estimate is greater than the number of historical passengers, the capped seed estimate is set at the number of historical passengers*0.5; otherwise, the capped seed estimate is set equal to base seed estimate.

Before deriving base seed estimate, a discussion regarding capacity is presented. Capacity is reduced to effective capacity in order to reflect conservatism in reservations systems; the difference between actual seats count and effective capacity is often called spoilage. There are two reasons for spoilage. One reason is to prevent denied boardings, when someone is turned away from a flight at the gate due to the flight. Under normal circumstances, reservation systems allow an airline to sell more tickets than there is capacity on a flight in order to adjust for the no-show rate at the gate (referred to as “overbooking”). Excessive overbooking is undesirable, however, because of the cost associated with denied boardings. If the average number of people who show up at the gate equaled the number of seats, then, approximately half the time passengers at the gate would be in excess of capacity, and denied boardings would occur. To prevent this, reservations are limited so that the average demand at the gate is slightly below the capacity.

Yield management—attempts to maximize the value of each seat—introduces further conservatism in reservations systems. Late bookings—bookings made close in to the flight date—are generally made at higher fares than those made further in advance of the flight. Thus, effective yield management preserves seats for late booking for high fare demand by denying reservations to some discount demand. These denied discount bookings are therefore always spilled, even though the high fare demand may not always materialize. However, due to the higher rates paid by late bookings, yield management systems are willing to take the chance. Extra spoilage is a consequence of this calculated risk.

Effective capacity may be set in multiple ways. In one example, effective capacity is set at segment capacity−(capacity scaling factor*square root of segment capacity), where the capacity scaling factor determines how conservative the reservation system is. The higher the scaling factor, the more seats are set aside to protect against denied boardings or capture higher fare demands. High costs for denied boardings or a low value for spilled demand will cause the factor to be high. Different values are appropriate when demand is hard to forecast or when forecasting is more accurate. Consequently, it is understood by those in the art that values for the capacity scaling factor can be derived empirically.

Returning to the demand estimate, a base seed estimate is calculated as follows:

Base seed estimate=(k factor²−0.45/historical passengers)+(0.45/historical passengers)*effective segment capacity²/(effective segment capacity−historical passengers)−0.036*effective capacity

where segment capacity is the available seats offered during the historical period of a given flight segment and the determination of effective segment capacity was described above. K factor is the ratio of standard deviation to mean of demand and represents demand variation. More specifically, the K factor is composed of a cyclic component and a random component. The cyclic component captures variations caused by such demand cycles as days of week and seasonal trends, as well as the differences in demand across flights in a group of flights; whereas, the random component depends only on the size of mean value of demand. In an example embodiment, the K factor has a value of 0.3 although other values are contemplated by this disclosure.

Next, the first demand estimate is spilled into an estimate of passengers. The first passenger guess is set to the first demand estimate−spilled passengers. In one embodiment, spilled passengers is derived as follows:

Spilled passengers=(k factor/1.7)*ln(1+ê(−1.7*effective segment capacity−segment demand)/(k factor*segment demand))*segment demand

where segment capacity is the available seats offered during the forecast period on a given flight, effective segment capacity=segment capacity−(capacity scaling factor*square root of segment capacity), segment demand is the sum of final forecast demand for all itineraries involving the given flight segment, capacity scaling factor, e.g., having a value of 1 and k factor having a value of 0.3. This computation is intended to be illustrative; other techniques for computing the number of spilled passengers also fall within the broader aspects of this disclosure.

This de-spill process is then repeated until two consecutive estimates of historical demand result in passenger counts are within a predefined percentage (e.g., 1%) of each other or until a certain number of iterations is reached, thereby yielding the final historical demand for the given segment. This process is repeated for each segment to obtain a historical demand estimate for each segment.

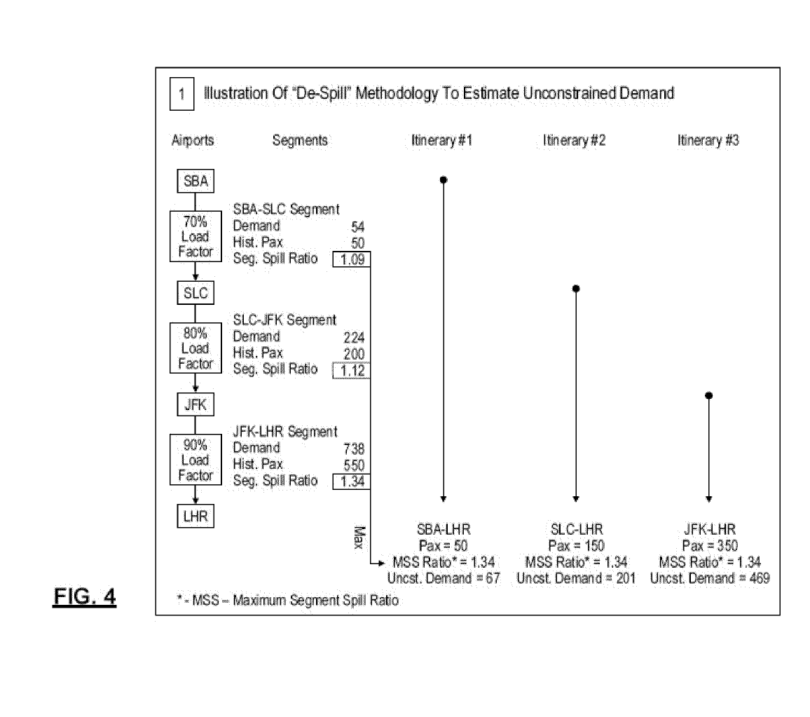

FIG. 4 illustrates how the de-spill process is applied to an itinerary having multiple segments. For illustration purposes, the itinerary is comprised of three segments. The segment spill ratio is set to the final segment demand divided by the total number of passengers historically transported on the segment. In this example, the spill ratio is 1.09 on a first segment with 70 percent load factor, 1.12 on a second segment with 80 percent load factor, and 1.34 on a third segment with 90 percent load factor. The maximum segment spill ratio across all of the segments is then used to compute unconstrained demand. Specifically, the unconstrained demand for each segment is set at the number of passengers who initiated travel on the given segment multiplied by the maximum segment spill ratio. In this example, the unconstrained demand for the first segment, the second segment and the third segment is 67, 201 and 469, respectively.

Returning to FIG. 3, the final historical demand for the airline's itinerary in the given market serves as an input to forecasting demand for the given airline during a future period. In an example embodiment, the base forecasted demand for the given airline is computed by multiplying the final historic demand 31 for the given airline itinerary by the carrier forecast ratio (i.e., an expected percentage change in the airline's market share for the given itinerary 32 during the future period). In other embodiments, the base forecasted demand may serve as the final forecasted demand 34.

For new itineraries, there are no recent experiences on which to base number of passengers. In this case, the base forecast demand may be computed in a similar manner except that demand for a corresponding itinerary is replaced with the total industry demand for all itineraries in the given market during the historical period. The base forecasted demand is therefore calculated as the new itinerary's QSI share of the market during the forecast period, multiplied by the total industry demand in the historical period.

The base forecasted demand for the given airline may be further refined to account to any change in the overall market size. For example, the base forecasted demand may be multiplied by the market forecast ratio (i.e., a percentage change in the overall market size), thereby yielding the final forecasted demand for the airline in the given market. In the example embodiment, the market forecast ration can be computed by dividing the QSI score for all of the airlines servicing the market in the forecast period by the QSI score for all of the airlines servicing the market in the historical period. This approach differs from conventional techniques of multiplying historical passenger totals by an expected growth factor. Additionally, the inaccuracies of the QSI score are cancelled through the use of a ratio of QSI scores. Other ways for determining the projected change in a given market are contemplated by this disclosure as noted above.

Lastly, the final forecasted demand 34 is correlated with the airline's forecasted capacity 35 to yield a forecasted quantity of passengers 36 to be transported by the airline in the given market during the forecast period. In other words, the number of passengers forecasted to take a particular flight is bound by the airline's capacity (i.e., the number of available seats on the flight). The number of passengers that exceed the airline's forecasted capacity is referred to as spilled passengers because they are unable to fly with the airline. In one embodiment, the number of spilled passengers is computed as the forecasted demand minus the forecasted capacity. In a more robust embodiment, the number of spilled passengers is computed as described above.

For each itinerary, the final number of forecasted passengers is computed by multiplying the final forecast demand by the minimum segment spill demand ratio across all segments in the itinerary. The segment spill ratio is set to the base passengers divided by the segment demand and the base passengers is set to the segment demand plus the number of spilled passengers. For each itinerary, the final forecast revenue is set to the final number of forecasted passengers multiplied by the base forecast fare. While the forecasting methods have been applied at an itinerary level, it is readily understood that forecasting can also be done at a market level and/or across markets. That is, the forecasting method described above may be applied to each of the markets serviced by the given airline, thereby yielding an overall forecast for the airline.

A variant of this example method may draw a distinction between premium passengers and economy passengers. Airlines may segment premium passengers from economy passengers in different ways. For example, premium passengers may be those assigned to first class or business seats while the remainder of passengers is deemed economy passengers. In another example, premium passengers may be those passengers who buy their tickets within two weeks of the departure date; whereas, economy passengers may be those passengers who buy their tickets more than two week prior to the departure date. Other methods for distinguishing between premium and economy passengers fall within the scope of this disclosure.

Historical data for the airlines, including the count of passengers transported on each flight segment along with the fare paid by the passenger, is segmented into premium passengers and economy passengers. When generating a forecast, the method set forth above is applied in the same manner to both segments of data up to step 36. For illustration purposes, this may yield a forecasted demand of:
Forecasted premium demand: 150
Forecasted economy demand: 1,000
   with a forecasted capacity of only 850 seats. In this case, the number of forecasted passengers exceeds the forecasted capacity and thus a total of 300 economy passengers are spilled from the flight to ensure passage for the premium passengers.

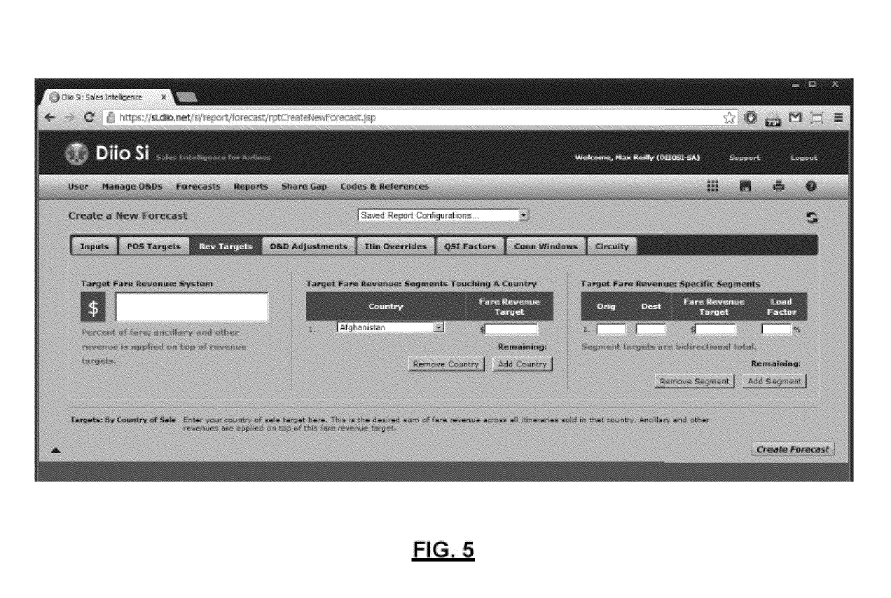

In the example embodiment, the forecasting tool 12 further enables the user to refine an overall forecast. For example, the user may define revenue targets for the given airline. Revenue targets may be set at a segment level, a country level, and a system level as shown, for example in FIG. 5. Example computation for each of these levels is set forth below.

At a segment level, the forecast tool 12 adjusts the final passenger forecast 36 in order to meet the user-defined revenue goal for the relevant segment. To do so, the forecast tool 12 holds fare constant and proportionally adjusts the final passenger forecast on each itinerary touched by the relevant segment to meet the segment revenue target. More specifically, for each relevant itinerary, adjusted number of passengers is set equal to final passenger forecast for the segment multiplied by the segment passenger adjustment, where the segment passenger is set equal to segment revenue target divided by forecast segment revenue. For each relevant itinerary, the adjusted number of passengers is then multiplied by the average fare in the corresponding itinerary. These products are in turn summed together and equated to the adjusted segment revenue.

At a country level, the forecast tool 12 adjusts the final passenger forecast 36 in order to meet a user-defined revenue goal set for the country. In an example implementation, the forecast tool 12 adjusts forecast passengers on any itinerary originating from that country while maintaining fares paid constant. Country adjusted revenue is set to the final passenger forecast multiplied by the country revenue target adjustment, where the country revenue target adjustment is set to the country revenue target (defined in an applicable currency quantity) divided by the sum of all revenue across all itineraries operated by the given airline which originated in the country during the forecast period. Likewise, the country revenue adjusted passengers is set at the final passenger forecast multiplied by the country revenue target adjustment. POS adjusted revenue and/or revenue adjusted passengers may be computed in similar to manner except as applied to all itineraries sold from a designated country. In some embodiments, it is envisioned that the number of adjusted passengers may be capped at 100% load factor. In other embodiments, the number of adjusted passengers can exceed 100% load factor. In either case, the forecast tool may provide a warning to the user when the revenue goal requires load factors in excess of one hundred percent.

At a system level, the forecast tool 12 adjusts forecast passengers across all itineraries while maintaining fares paid constant. System adjusted revenue is set to the final passenger forecast multiplied by the system revenue target adjustment, where the system revenue target adjustment is set to the system revenue target (defined in an applicable currency quantity) divided by the sum of all revenue across all itineraries operated by the given airline during the forecast period. Likewise, the system revenue adjusted passengers is set at the final passenger forecast multiplied by the system revenue target adjustment. Again, it is envisioned that the forecast tool may provide a warning to the user when the revenue goal requires load factors in excess of one hundred percent.

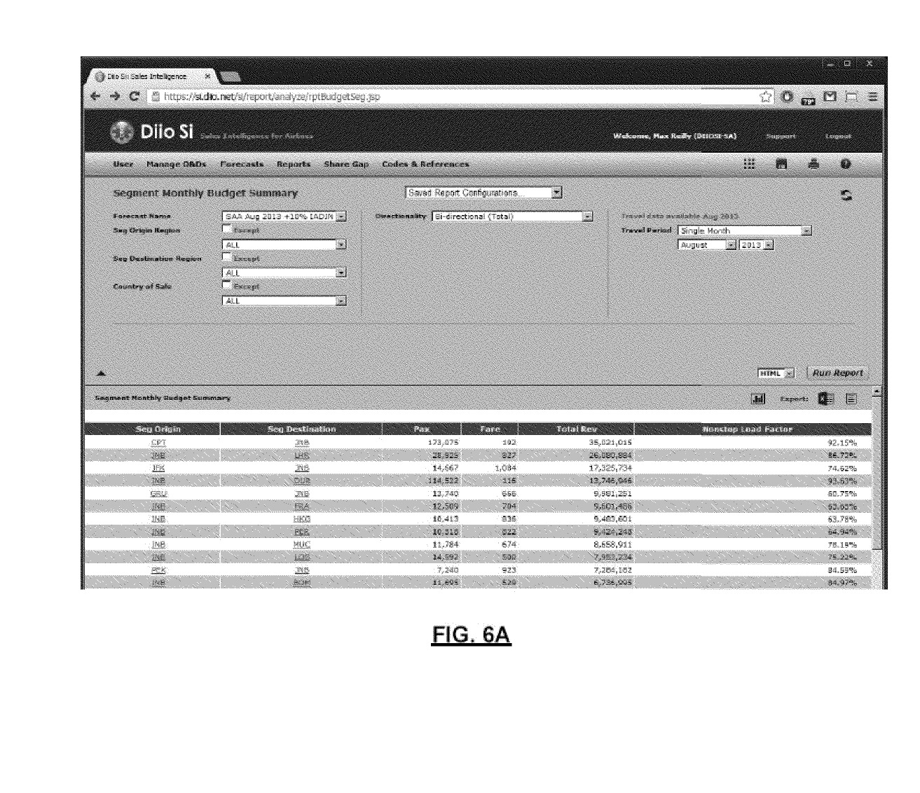

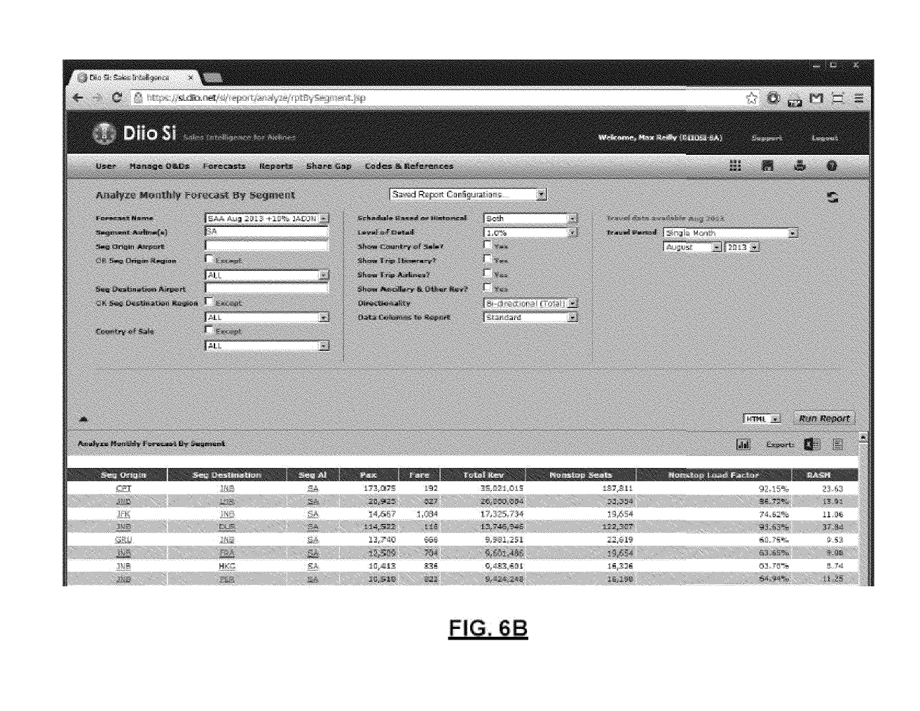

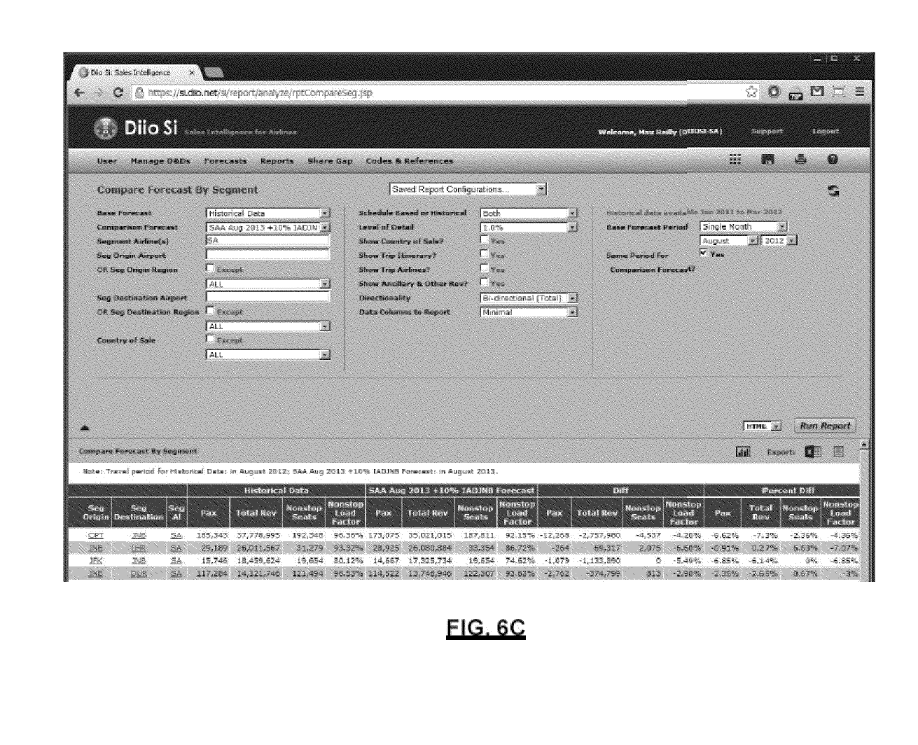

To meet a revenue goal, the forecast tool 12 may adjusts the final passenger forecast 36 up to a default load factor that is less than 100 percent (e.g., 98% or some other user specified value). Once the final passenger forecast has been adjusted to meet the default load factor, the final passenger forecast remains fixed and the fares are adjusted (i.e., increased) until the revenue goal is meet. A few example reports generated by the forecast tool using the methods set forth above are shown in FIG. 6A-6C. These examples pertain to reporting at the segment level but similar reports are envisioned at the other levels as well.

In another example, the forecasting tool 12 enables the user to define load factor targets for select segments. In this case, the forecast tool 12 holds the revenue on each itinerary touching the segment constant and adjusts the number of passengers needed to meet the goal. The segment load factor adjusted passengers is set to the final passenger forecast divided by the load factor target adjustment, where the load factor target adjustment is set to the segment load factor target divided by the forecast load factor. If applicable, the segment revenue adjusted passengers may be used in place of the final passenger forecast. The segment load factor adjusted fare is set to the final passenger forecast divided by the segment load factor adjusted passengers. Likewise, the segment revenue adjusted passengers may be used in place of the final passenger forecast, if applicable.

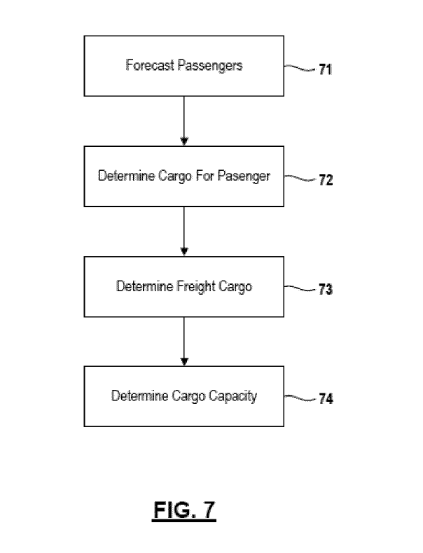

Principles described above in relation to forecasting passengers for a given itinerary can also be extended to forecasting cargo. With reference to FIG. 7, cargo capacity and related metrics are computed as a function of the forecasted number of passengers for the given itinerary. Inputs to this computation may include but are not limited to an average weight per passenger, a percent of passengers checking bags, an average baggage weight per passenger, and an average baggage density. Values for these inputs may be input by the user or retrieved from a database. The amount of cargo is constrained primarily by the weight limit of the plane and volume of space for transporting the cargo.

In an example embodiment, the number of passengers expected on a given itinerary is forecasted at 71 using, for example the method set forth above. Given the forecasted number of passengers, the amount of cargo attributable to the passengers can then be computed at 72. Specifically, the total weight of checked baggage is computed by multiplying the number of forecasted passengers by the percent of passengers checking bags and the average baggage weight per passenger. The volume of space taken up by the checked baggage can also be computed by multiplying the number of forecasted passengers by the percent of passengers checking bags by the average baggage density per passenger. Other techniques for computing such metrics are also contemplated by this disclosure.

Next, the expected amount of cargo that is not attributable to passengers is computed at 73 (also referred to as freight cargo). In one embodiment, the expected amount of cargo may be correlated directly to the amount of cargo transported by the carrier previously, where such historical freight cargo demand is retrieved from a database. In other embodiments, the expected amount of freight cargo may be forecasted based in part on the historical freight cargo. In either case, the amount of freight cargo is reported in terms of both weight and volume.

Forecasted cargo capacity can then be derived by adding the amount of passenger cargo with the amount of freight cargo and subtracting this sum from the capacity limits associated with the vehicle (e.g., aircraft) servicing the given itinerary, where the capacity limits are readily available from the vehicle manufacturer. When either the weight limit or the volume limit is exceeded, cargo will need to be spilled from the aircraft. The forecasting tool 12 automates the computation for cargo capacity and makes such metrics visible to a user. A carrier is then able to proactively manage and maximize cargo capacity in a manner similar to passengers.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for forecasting passengers for a given itinerary of a carrier in a given market, where the given market is defined by an origin and a destination and the given itinerary transports passengers from the origin to the destination, comprising:
receiving an expected percentage change in market share for a given itinerary of the carrier during a future time period;
determining a percentage change in overall quantity of passengers in the given market during the future time period;
receiving quantity of passengers transported by the carrier via the given itinerary during a preceding time period, where the preceding time period having a duration substantially equal to the future time period; and
determining a forecasted quantity of passengers transported by the carrier via the given itinerary during the future time period as a function of the quantity of passengers transported by the carrier via the given itinerary during a preceding time period, the expected percentage change in market share for the given itinerary during a future time period and the percentage change in quantity of passengers in the given market during the future time period, where the steps of determining a percentage change in quantity of passengers, determining quantity of passengers transported by the carrier and determining a forecasted quantity of passengers transported by the carrier during the future time period are executed by a processor of a computing device.

2. The method of claim 1 further comprises determining the quantity of passengers transported by the carrier via the given itinerary during a preceding time period from a source of historic traffic data for the carrier, including a count of passengers transported by the carrier via the given itinerary during a preceding time period.

3. The method of claim 2 further comprises adjusting itineraries of the carrier during the future time period based on the forecasted quantity of passengers to be transported by the carrier via the given itinerary during the future time period.

4. The method of claim 1 wherein receiving an expected percentage change further comprises
determining a forecasted quality of service index (QSI) share for the given itinerary of the carrier in the future time period;
determining a historic QSI share for the given itinerary of the carrier in the preceding time period; and
determining the expected percentage change based on the forecasted QSI share and the historic QSI share, where the forecasted QSI share and the historic QSI share quantify the value of the given itinerary of the carrier to passengers.

5. The method of claim 4 wherein the carrier is further defined as an airline and determining the forecasted QSI share uses at least one factor selected from the group consisting of a number of stops between an origin and a destination, type of aircraft, flight frequency, travel time and time of day.

6. The method of claim 1 wherein determining a percentage change in overall quantity of passengers further comprises
determining a forecasted quality of service index (QSI) score for a select group of carriers servicing the given market in the future time period;
determining a historic QSI score for the select group of carriers in the given market in the preceding time period; and
determining the percentage change in quantity of passengers based on the forecasted QSI score and the historic QSI score, where the forecasted QSI score and the historic QSI score quantify the value of travel itineraries of the carrier in a market to passengers.

7. The method of claim 1 further comprises determining a forecasted quantity of passengers by multiplying the quantity of passengers transported by the carrier via the given itinerary during a preceding time period by the expected percentage change in market share for the given itinerary of the carrier during a future time period and by the percentage change in quantity of passengers in the given market during the future time period.

8. A computer-implemented method for forecasting passengers for a given itinerary of an airline in a given market, where the given market is defined by an origin and a destination and the given itinerary transports passengers from the origin to the destination, comprising:
determining a forecasted quality of service index (QSI) share for the given itinerary of the airline in a future time period;
determining a historic QSI share for the given itinerary for the airline in a time period preceding the future time period, where the preceding time period having a duration substantially equal to the future time period;
determining an expected percentage change in market share for the given itinerary of the airline during the future time period based on the forecasted QSI share and the historic QSI share, where the forecasted QSI share and the historic QSI share quantify the value of the given itinerary of the airline to passengers in a market;
receiving a percentage change in overall quantity of passengers in the given market during the future time period;
determining quantity of passengers transported by the airline via the given itinerary during a preceding time period; and
determining a forecasted quantity of passengers transported by the airline via the given itinerary during the future time period as a function of the quantity of passengers transported by the airline via the given itinerary during a preceding time period, the expected percentage change in market share for the given itinerary during a future time period and the percentage change in quantity of passengers in the given market during the future time period, where the steps of determining a percentage change in quantity of passengers determining quantity of passengers transported by the carrier and determining a forecasted quantity of passengers transported by the airline during the future time period are executed by a processor of a computing device.

9. The method of claim 8 further comprises determining the quantity of passengers transported by the airline via the given itinerary during a preceding time period from a source of historic traffic data for the airline, including a count of passengers transported by the airline via the given itinerary during a preceding time period.

10. The method of claim 8 further comprises adjusting itineraries of the airline during the future time period based on the forecasted quantity of passengers to be transported by the airline via the given itinerary during the future time period.

11. The method of claim 8 wherein determining the forecasted QSI score uses at least one factor selected from the group consisting of a number of stops between an origin and a destination, type of aircraft, flight frequency, and travel time.

12. The method of claim 1 wherein determining a percentage change further comprises
determining a forecasted quality of service index (QSI) score for a group of the airlines servicing the given market in the future time period;
determining a historic QSI score for the group of airlines in the given market in the preceding time period; and
determining the percentage change in quantity of passengers based on the forecasted QSI score and the historic QSI score, where the forecasted QSI score and the historic QSI score quantify the value of travel itineraries of the airline in a market to passengers.
